(19) United States
(12) Patent Application Publication
(10) Pub. No.: US 2022/0296443 A1
(43) Pub. Date: Sep. 22, 2022

(54) Hydro Wash Bed

(71) Applicant: Sheila Annette Jefferson, Matteson, IL (US)

(72) Inventor: Sheila Annette Jefferson, Matteson, IL (US)

(73) Assignee: Sheila Annette Jefferson, Matteson, IL (US)

(21) Appl. No.: 17/803,291

(22) Filed: Apr. 25, 2022

(51) Int. Cl. A61G 7/00; A61G 7/002

(52) U.S. Cl. CPC A61G 7/0005; A61G 7/002; A61G 2203/30

(57) ABSTRACT

The Hydro Wash Bed allows people physically incapacitated who cannot access normal means of bathing or washing to have a bath. The Hydro Wash Bed is made of lightweight plastic that has two handles which sits on four moveable rubber wheels. The Hydro Wash Bed tilts up and down, folds up and down and tilts side to side. The Hydro Wash Bed has sprayers that will allow clean water to be pumped in from an existing faucet and allow dirty water to be removed through a drain. The Hydro Wash Bed folds so that storage is easy. The Hydro Wash Bed can be used in medical facilities for people unable to independently take a bath or shower and homes for elderly people unable to access their own bathrooms. The Hydro Wash Bed is lightweight plastic that is easily wiped down for sanitary and germ control and elimination purposes.

The Hydro Wash Bed is a wide flat lightweight plastic bed with wheels that moves.

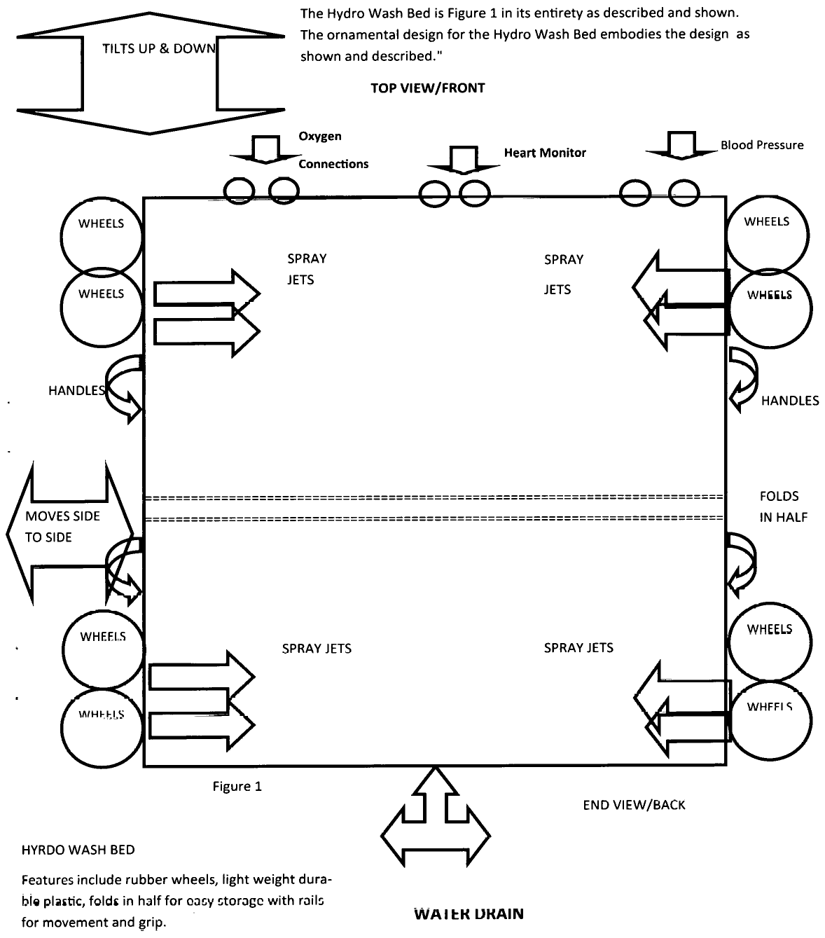

The Hydro Wash Bed has handles and a drain with sprayers attached to the side of the wash bed. The Hydro Wash Bed has ports for oxygen, blood pressure, and heart monitors. The Hydro Wash Bed moves side to side, up and down, folds up and down and stores easily. 5 The Hydro Wash Bed has a drain that allows water that was used to flow out of the holes in the bed into the drain to be emptied. The Hydro Wash Bed in FIG. 1 in its entirety as described and shown. The ornamental design for the Hydro Wash Bed embodies the design as shown and described.” The Hydro Wash Bed has a port connected to the drain for an existing water faucet so clean water can flow in and dirty water can flow out. This is a wash bed for people who are physically unable to bathe or shower daily without assistance. It will make bathing small children and the elderly convenient and safe. It is designed for medical and home use. Features include rubber wheels, light weight durable plastic, folds in half for easy storage with rails for movement and grip.

1. The Hydro Wash Bed is a wide flat lightweight plastic bed with wheels that move (Independent Claim).

2. The Hydro Wash Bed has handles and a drain with sprayers attached to the side of the wash bed (Dependent Claim)

3. The Hydro Wash Bed has ports for oxygen, blood pressure, and heart monitors (Dependent Claim).

4. The Hydro Wash Bed moves side to side, up and down, folds up and down and stores easily (Dependent Claim).

5. The Hydro Wash Bed has a drain that allows water that was used to flow out of the holes in the bed into the drain to be emptied. (Dependent Claim).

6. The Hydro Wash Bed in FIG. 1 in its entirety as described and shown. The ornamental design for the Hydro Wash Bed embodies the design as shown and described.” (Dependent Claim).

7. The Hydro Wash Bed has a port connected to the drain for an existing water faucet so clean water can flow in. (Dependent Claim).
